(19) United States
(12) Patent Application Publication
(10) Pub. No.: US 2026/0142523 A1
(43) Pub. Date: May 21, 2026

(54) DRIVE DEVICE

(71) Applicant: DENSO CORPORATION, Kariya-city (JP)

(72) Inventor: Tomoaki YOSHIMI, Kariya-city (JP)

(21) Appl. No.: 19/447,659

(22) Filed: Jan. 13, 2026

Related U.S. Application Data
(63) Continuation of application No. PCT/JP2024/024798, filed on Jul. 9, 2024.

(30) Foreign Application Priority Data
Jul. 18, 2023 (JP) 2023-116747

(51) Int. Cl. H02K 5/22; H02K 5/10; H02K 11/33

(52) U.S. Cl. CPC H02K 5/225; H02K 5/10; H02K 11/33; H02K 2211/03

(57) ABSTRACT

A drive device includes an electric motor and a controller. The electric motor includes: a motor housing; a stator fixed to the motor housing; a plurality of motor wires wound around the stator; a rotor configured to be rotated in response to energization of the motor wires; and a shaft configured to be rotated integrally with the rotor. The motor housing includes a motor case formed in a tubular shape. The controller includes: a circuit board on which a plurality of electronic components configured to control a drive operation of the electric motor are mounted; and a controller housing that receives the circuit board. The controller is fixed to one end portion of the motor case. At least one of the electronic components is sealed in a state where the at least one of the electronic components is embedded in the controller housing made of an electrically insulating material.

### CROSS REFERENCE TO RELATED APPLICATIONS

This application is a continuation application of International Patent Application No. PCT/JP 2024/024798 filed on Jul. 9, 2024, which designated the U.S. and claims the benefit of priority from Japanese Patent Application No. 2023-116747 filed on Jul. 18, 2023. The entire disclosures of all of the above applications are incorporated herein by reference.

### TECHNICAL FIELD

The present disclosure relates to a drive device.

### BACKGROUND

Previously, an electric motor of an integrated electromechanical type, in which a controller is integrally formed on one axial side of the electric motor, has been proposed. For example, a heat sink is fixed inside a housing of the electric motor with an interference fit.

### SUMMARY

According to the present disclosure, there is provided a drive device that may include an electric motor and a controller. The electric motor may include: a motor housing which includes a motor case formed in a tubular shape; a stator which is fixed to the motor housing; a plurality of motor wires which are wound around the stator; a rotor which is configured to be rotated in response to energization of the plurality of motor wires; and a shaft which is configured to be rotated integrally with the rotor. The controller may include: a circuit board on which a plurality of electronic components configured to control a drive operation of the electric motor are mounted; and a controller housing that receives the circuit board. The controller may be fixed to one end portion of the motor case which faces in an axial direction of the electric motor. At least one of the plurality of electronic components may be sealed in a state where the at least one of the plurality of electronic components is embedded in the controller housing made of an electrically insulating material.

### BRIEF DESCRIPTION OF DRAWINGS

The drawings described herein are for illustrative purposes only of selected embodiments and not all possible implementations, and are not intended to limit the scope of the present disclosure.

FIG. 1 is a schematic configuration diagram of a steering system according to a first embodiment.

FIG. 2 is a cross-sectional view of a drive device according to the first embodiment.

FIG. 3 is a schematic diagram illustrating a connection between a motor case and an ECU case according to the first embodiment.

FIG. 4 is a flowchart illustrating an assembly process of the drive device according to the first embodiment.

FIG. 5 is an explanatory diagram illustrating assembly of the motor case and a stator according to the first embodiment.

FIG. 6 is an explanatory diagram illustrating assembly of a rotor assembly according to the first embodiment.

FIG. 7 is an explanatory diagram illustrating assembly of a motor assembly according to the first embodiment.

FIG. 8 is an explanatory diagram illustrating assembly of an ECU case and an ECU assembly to the motor assembly according to the first embodiment.

FIG. 9 is a cross-sectional view of a drive device according to a second embodiment.

FIG. 10 is a cross-sectional view of a drive device according to a third embodiment.

FIG. 11 is a cross-sectional view of a drive device according to a fourth embodiment.

FIG. 12 is a flowchart illustrating an assembly process of the drive device according to the fourth embodiment.

FIG. 13 is a cross-sectional view of a drive device according to a fifth embodiment.

FIG. 14 is an explanatory diagram illustrating assembly of an ECU case to a motor assembly according to the fifth embodiment.

FIG. 15 is an explanatory diagram illustrating assembly of an ECU assembly to an ECU case according to the fifth embodiment.

FIG. 16 is a cross-sectional view of a drive device according to a sixth embodiment.

FIG. 17 is a cross-sectional view of a drive device according to a seventh embodiment.

FIG. 18 is a cross-sectional view of a drive device according to an eighth embodiment.

FIG. 19 is a cross-sectional view of a drive device according to a ninth embodiment.

FIG. 20 is a cross-sectional view of a drive device according to a tenth embodiment.

FIG. 21 is a flowchart illustrating an assembly process of the drive device according to the tenth embodiment.

FIG. 22 is an explanatory diagram illustrating assembly of a motor assembly and an ECU assembly according to the tenth embodiment.

FIG. 23 is a cross-sectional view of a drive device according to an eleventh embodiment.

### DETAILED DESCRIPTION

Previously, an electric motor of an integrated electromechanical type, in which a controller is integrally formed on one axial side of the electric motor, has been proposed. For example, a heat sink is fixed inside a housing of the electric motor with an interference fit.

In a case where heat generated from heat-generating devices is dissipated to the heat sink, the heat sink stores the heat and transfers it to the motor case, from which it is then radiated into the surrounding space. The heat sink and the motor case, which form a heat dissipation path, are made of a metal with good thermal conductivity. Here, for example, if the component, which forms the heat dissipation path, such as the heat sink, is made of a material other than metal (e.g., resin), there is a risk that heat dissipation will not keep up with the amount of heat generated. In addition, in a case where the heat sink is provided inside the motor case, a heat-generating component can only be placed at a location facing the heat sink.

A drive device of the present disclosure includes an electric motor and a controller. The electric motor includes: a motor housing which includes a motor case formed in a tubular shape; a stator which is fixed to the motor housing; a plurality of motor windings which are wound around the stator; a rotor which is configured to be rotated in response to energization of the plurality of motor windings; and a shaft which is configured to be rotated integrally with the rotor.

The controller includes: a circuit board on which a plurality of electronic components configured to control a drive operation of the electric motor are mounted; and a controller housing that receives the circuit board. The controller is fixed to one end portion of the motor case which faces in an axial direction of the electric motor. At least one of the plurality of electronic components is sealed in a state where the at least one of the plurality of electronic components is embedded in the controller housing made of an electrically insulating material. By embedding the at least one of the plurality of electronic components in the controller housing, heat from the at least one of the plurality of electronic components can be dissipated to the controller housing.

Hereinafter, a drive device of the present disclosure will be described with reference to the drawings. In the following description, the same reference signs are given to substantially the same portions among the embodiments, and the redundant description thereof will be omitted for the sake of simplicity.

### First Embodiment

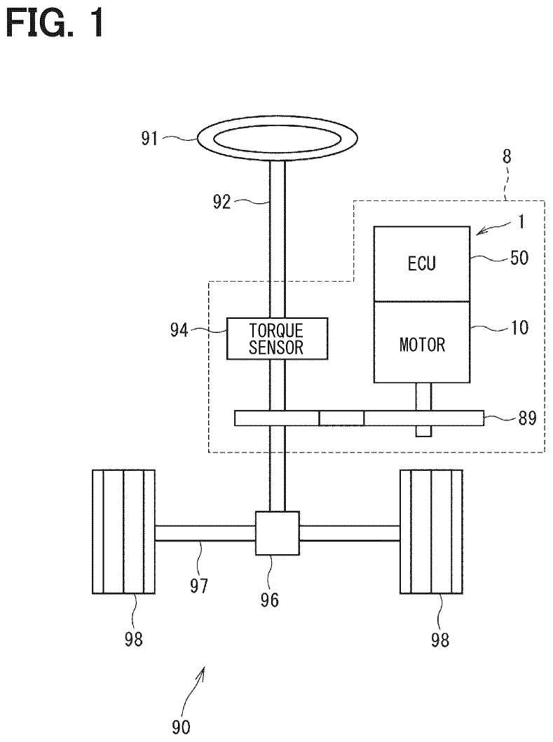

FIGS. 1 to 8 show the first embodiment. As shown in FIG. 1, a drive device 1 includes an electric motor 10 and an ECU (serving as a controller) 50 and is applied to an electric power steering apparatus 8. FIG. 1 shows a configuration of a steering system 90 including the electric power steering apparatus 8. The steering system 90 includes: a steering wheel 91, which serves as a steering member; a steering shaft 92; a pinion gear 96; a rack shaft 97; a plurality of wheels 98; and the electric power steering apparatus 8.

The steering wheel 91 is connected to the steering shaft 92. A torque sensor 94, which is configured to detect steering torque, is installed on the steering shaft 92. The pinion gear 96 is installed to a distal end portion of the steering shaft 92. The pinion gear 96 is meshed with the rack shaft 97. A pair of wheels 98 are coupled to two ends of the rack shaft 97 via tie rods or the like.

When a driver of the vehicle rotates the steering wheel 91, the steering shaft 92 connected to the steering wheel 91 is rotated. The rotational motion of the steering shaft 92 is converted into linear motion of the rack shaft 97 by the pinion gear 96. The pair of wheels 98 are steered at an angle corresponding to the amount of displacement of the rack shaft 97.

The electric power steering apparatus 8 includes the drive device 1 and a speed reducing gear mechanism 89. The speed reducing gear mechanism 89 is a drive force transmission device that reduces a rotational speed of rotation outputted from the electric motor 10 and transmits the rotation to the steering shaft 92. In other words, the electric power steering apparatus 8 of the present embodiment is a so-called “column-assist type,” and the steering shaft 92 can be said to be a drive subject to be driven. Alternatively, a so-called “rack-assist type” may be adopted in which the rotation of the electric motor 10 is transmitted to the rack shaft 97.

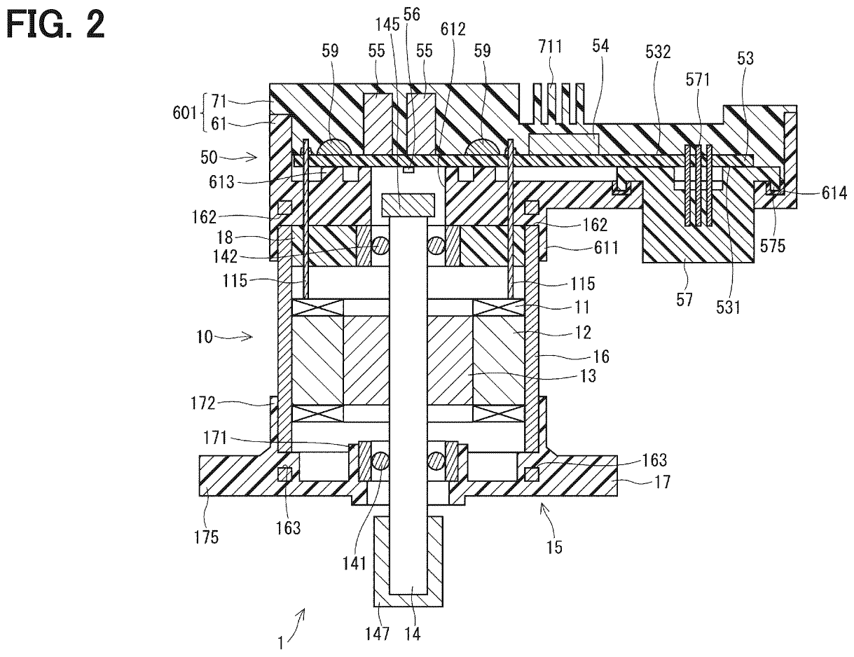

The electric motor 10 is, for example, a three-phase brushless motor. The electric motor 10 outputs a part or all of the torque required for the steering. The electric motor 10 is driven by electric power supplied from a battery (not shown) to rotate the speed reducing gear mechanism 89 in a forward or reverse direction. The drive device 1 includes the ECU 50 disposed on one side of the electric motor 10 in an axial direction of the electric motor 10 and is a so-called “integrated electromechanical type”. By adopting the integrated electromechanical type, the electric motor 10 and the ECU 50 can be efficiently arranged in a vehicle with limited mounting space. Hereinafter, an axial direction and a radial direction refer to an axial direction and a radial direction of the electric motor 10. Additionally, a lower side of a sheet of FIG. 2 and the like will be referred to as an output end side.

As shown in FIG. 2, the electric motor 10 includes a stator 12, a rotor 13, a shaft 14 and a motor housing 15. The stator 12 is fixed to the motor housing 15, and a plurality of motor wires 11 are wound around the stator 12. The illustration of the motor wires 11 is omitted in drawings other than FIG. 2. The rotor 13 is disposed on the radially inner side of the stator 12 and is configured to be rotated relative to the stator 12.

The shaft 14 is fitted into the rotor 13 to rotate integrally with the rotor 13. The shaft 14 is rotatably supported by the motor housing 15 via two bearings 141, 142. One end portion of the shaft 14, which faces the ECU 50, is exposed from the motor housing 15 toward the ECU 50, and a sensor magnet 145 is installed to the one end portion of the shaft 14. The other end portion of the shaft 14, which is opposite to the ECU 50, is an output end of the shaft 14, to which a pulley 147 is installed and is coupled to the speed reducing gear mechanism 89.

The motor housing 15 includes a motor case 16, a front frame 17 and a rear frame 18. The motor case 16 is formed in a tubular shape and is made of, for example, aluminum. The front frame 17 is integrally molded with the motor case 16 on the output end side, and an ECU case 61, which will be described later, is integrally molded with the motor case 16 on the ECU 50 side. In this specification, a state, in which at least one preformed member A is insert molded and, thereby, a member B is formed, is herein referred to as “integrally molded” or “formed as an integrally molded article,” and the members A and B may be made of the same material or of different materials.

The front frame 17 is made of, for example, a phenolic resin and seals an end portion of the motor case 16 disposed on the output end side. A bearing holding portion 171, an outer-wall contact portion 172, and a plurality of flange portions 175 are formed on the front frame 17. The bearing 141 is installed in the bearing holding portion 171.

The outer-wall contact portion 172 is formed in a tubular shape along the outer peripheral wall of the motor case 16 and extends toward the ECU 50 beyond a radially inner portion of the front frame 17 which is disposed on the radially inner side of the motor case 16. The provision of the outer-wall contact portion 172 suppresses ingress of water droplets and the like into the interior of the device from the connection between the motor case 16 and the front frame 17. The flange portions 175 project radially outward and are attached to a gearbox by fastening members such as screws (not shown). The flange portions 175 may be attached to a housing other than the gearbox.

The rear frame 18 is formed in a substantially circular plate shape and is made of, for example, a phenolic resin, and the rear frame 18 is fixed to the motor case 16 on the ECU 50 side. The bearing 142 is fixed to the rear frame 18. The frames 17, 18 hold the bearings 141, 142 and may be regarded as bearing-holding members.

The ECU 50 includes a circuit board 53, a connector 57 and an ECU housing 601. The circuit board 53 extends radially outward beyond a motor region of the circuit board 53, which overlaps with the motor case 16 upon projection of the motor case 16 onto the motor region in the axial direction. The circuit board 53 is fixed to the ECU housing 601 by fastening members 59 such as tapping screws. It is also acceptable to use fastening members other than the tapping screws. For example, the circuit board 53 may be fixed to the ECU housing 601 by resin staking. Hereinafter, a surface of the circuit board 53, which faces the electric motor 10, will be referred to as a motor-side surface 531, and the other surface of the circuit board 53, which is opposite to the electric motor 10, will be referred to as a cover-side surface 532.

Lead wires 115, which extend from the motor wires 11 of respective phases, extend toward the ECU 50 and are electrically connected to the circuit board 53 within the motor region. In this embodiment, the lead wires 115 of the motor wires 11 are soldered to the circuit board 53. However, as long as electrical connection is ensured, the connection method of the lead wires 115 is not limited to the soldering and may be solderless, such as a resilient connection using a press-fitting, or a mating connection using a socket connector.

Various electronic components, such as a plurality of heat-generating devices 54, a plurality of capacitors 55 and a rotational angle sensor 56, are mounted on the circuit board 53. In this embodiment, the heat-generating devices 54 and the capacitors 55 are mounted on the cover-side surface 532 of the circuit board 53. The heat-generating devices 54 include: a plurality of switching devices of an inverter configured to switch energization of the motor wires 11; a motor relay; and a power supply relay. The rotational angle sensor 56 is mounted at a corresponding location of the motor-side surface 531 opposed to the sensor magnet 145 and detects rotation of the electric motor 10 by sensing a rotating magnetic field of the sensor magnet 145. Note that, in the description of the assembly, illustration of the rotational angle sensor 56 is omitted.

The connector 57 is provided on the motor-side surface 531 of the circuit board 53 at a location outside the motor region, and connector terminals 571 are connected to the circuit board 53. A flange portion 575 is formed at an end portion of the connector 57, which faces the circuit board 53, and the flange portion 575 extends radially outward from a main body of the connector 57. A cross-section of the flange portion 575 has an L-shape such that a distal end part of the flange portion 575 projects in a direction opposite to the circuit board 53.

The ECU housing 601 includes the ECU case 61 and an ECU cover 71. A radially outer portion of the ECU housing 601 extends to a location outside the motor region. The ECU case 61 is made of, for example, an epoxy resin and is formed in a substantially bottomed tubular shape that opens toward the side opposite to the electric motor 10. The ECU case 61 is integrally molded with the motor case 16 and seals one end portion of the motor case 16 which faces the ECU 50 in the axial direction.

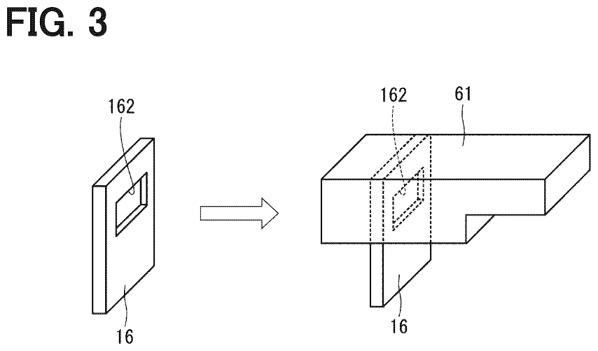

As shown in FIG. 3, the motor case 16 has a plurality of sealing holes 162 each of which extends through the motor case 16 in a plate-thickness direction of the motor case 16. The sealing holes 162 are formed at a corresponding location of the motor case 16 where the ECU case 61 is integrally molded with the motor case 16 such that the sealing holes 162 are spaced from each other and are arranged in a circumferential direction. When the motor case 16 and the ECU case 61 are integrally molded, the ECU case 61 is formed at the one end portion of the motor case 16, which faces the ECU 50, such that the ECU case 61 sandwiches a radially inner side part and a radially outer side part of the one end portion of the motor case 16. Here, the resin of the ECU case 61 penetrates into the sealing holes 162 to increase the joint strength between the ECU case 61 and the motor case 16.

Similarly, at a corresponding location of the motor case 16 where the front frame 17 is integrally molded with the motor case 16, a plurality of sealing holes 163 extend through the motor case 16 in the plate-thickness direction of the motor case 16 such that the sealing holes 163 are spaced from each other and are arranged in the circumferential direction. When the motor case 16 and the front frame 17 are integrally molded, the resin of the front frame 17 penetrates into the sealing holes 163 to increase the joint strength between the front frame 17 and the motor case 16.

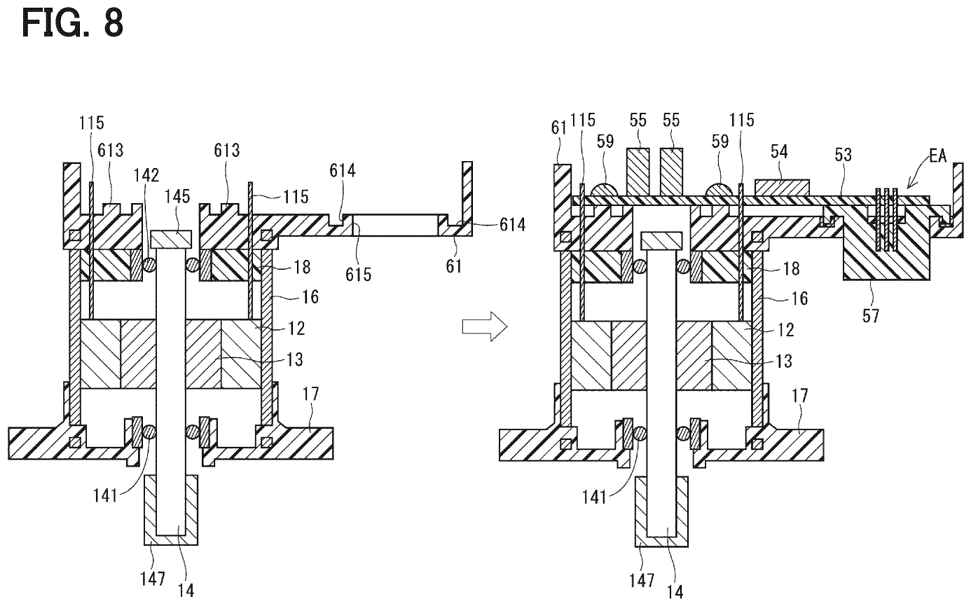

Returning to FIG. 2, the ECU case 61 has an outer-wall contact portion 611, a through-hole 612, a plurality of board holding portions 613, a connector mounting portion 614 and a connector insertion through-hole 615 (see FIG. 8).

The outer-wall contact portion 611 is formed in a tubular shape along the outer peripheral wall of the motor case 16 and extends toward the output end side beyond a radially inner portion of the ECU case 61 which is disposed on the radially inner side of the motor case 16. The outer-wall contact portion 611 suppresses ingress of water droplets and the like into the interior of the device from the connection between the motor case 16 and the ECU case 61. Note that the outer-wall contact portion 611 need not be provided, and, at the connection between the motor case 16 and the ECU case 61, the axial length of the radially outer portion of the ECU case 61, which is disposed on the radially outer side of the motor case 16, may be equal to or smaller than that of the radially inner portion of the ECU case 61. The same applies to the outer-wall contact portion 172 of the front frame 17. Furthermore, the indication of the outer-wall contact portion 611 is omitted as appropriate in the drawings other than FIG. 2.

The through-hole 612 extends through the ECU case 61 in the axial direction at a location that corresponds to the shaft 14, and the sensor magnet 145 is disposed inside the through-hole 612. The board holding portions 613 are formed on the ECU case 61 within the motor region, and the circuit board 53 is fixed to the board holding portions 613 by the fastening members 59. The connector 57 is attached to the connector mounting portion 614 with an adhesive or the like. In detail, the connector 57 is attached to the ECU case 61 by inserting the flange portion 575 into the connector mounting portion 614, to which the adhesive is applied, in a state where a main body of the connector 57 is inserted through the connector insertion through-hole 615, and an opening of the connector 57 is exposed to the outside.

The ECU cover 71 is made of, for example, an epoxy resin and is installed to the cover-side surface 532 of the circuit board 53. The ECU cover 71 is integrally molded with the ECU case 61 and resin-seals the circuit board 53, as well as the heat-generating devices 54 and the capacitors 55 that are mounted on the cover-side surface 532 of the circuit board 53. The ECU cover 71 has a device-mounting region, which overlaps with an area provided with the heat-generating devices 54 mounted on the circuit board 53 upon projection of this area provided with the heat-generating devices 54 onto the device-mounting region in the axial direction. The ECU cover 71 has a plurality of heat-dissipation fins 711 which are formed in the device-mounting region.

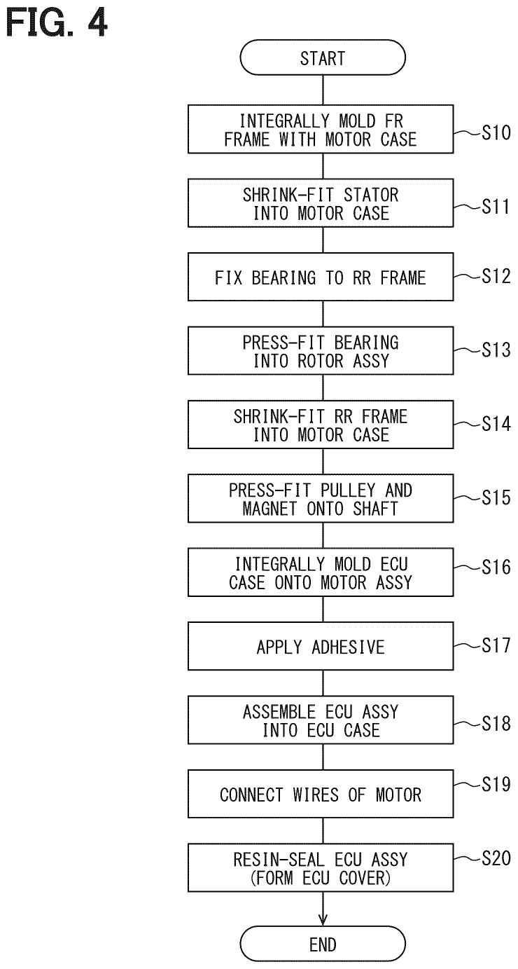

An assembly process of the drive device 1 according to this embodiment will be described with reference to a flowchart of FIG. 4 and FIGS. 5 to 8. Hereinafter, the term “step” in expressions such as step S10 is omitted, and only the symbol “S” is used.

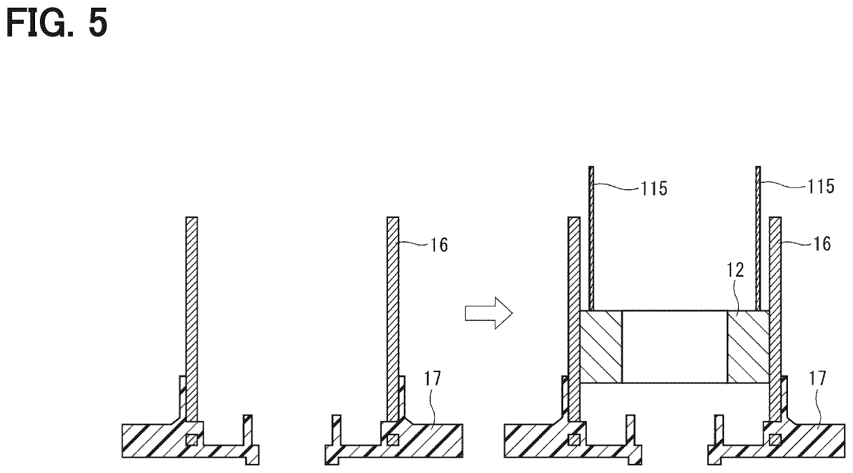

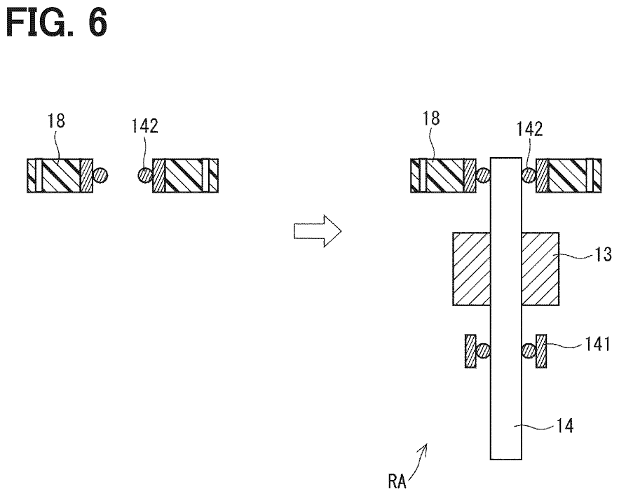

As shown in FIG. 5, in S10, the front (FR) frame 17 is integrally molded with the motor case 16. In S11, the stator 12 is shrink-fitted into the motor case 16. As shown in FIG. 6, in S12, the bearing 142 is fixed to the rear (RR) frame 18 by caulking, press-fitting, or the like. In S13, the bearings 141, 142 are press-fitted into a rotor assembly that is formed by press fitting the shaft 14 into the rotor 13. Note that S10 and S11, and S12 and S13, may be performed in a different order or in parallel.

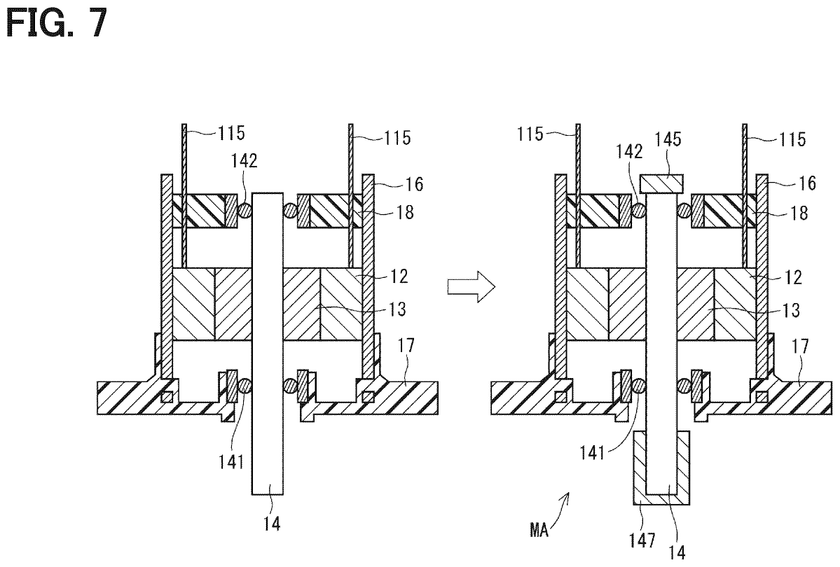

As shown in FIG. 7, in S14, the rotor assembly in a state shown on the right side of FIG. 6 is assembled to the motor case 16 in a state shown on the right side of FIG. 5. More specifically, the rear frame 18 is shrink-fitted into the motor case 16. The bearing 141 is inserted into the bearing holding portion 171 of the front frame 17. In S15, the pulley 147 is press-fitted onto the other end portion of the shaft 14, which faces the output end side, and the sensor magnet 145 is press-fitted onto the one end portion of the shaft 14, which faces the ECU 50. Hereinafter, an assembly in a state where the stator 12, the front frame 17 and the rear frame 18 are assembled to the motor case 16 is referred to as a motor assembly.

As shown in FIG. 8, in S16, the ECU case 61 is integrally resin-molded with the motor case 16 in the state of the motor assembly (see the left side of FIG. 8). In S17, the adhesive is applied to the connector mounting portion 614 of the ECU case 61. In S18, an ECU assembly, which is in a state where the connector 57 is assembled, is assembled to the ECU case 61 (see the right side of FIG. 8).

In S19, the lead wires 115 are electrically connected to the circuit board 53. If the connection between the lead wires 115 and the circuit board 53 is a solderless connection (e.g., a press-fit connection), the connection is completed when the ECU assembly is assembled to the ECU case 61 in S18, and therefore S19 is omitted. In S20, the ECU assembly is resin sealed to form the ECU cover 71 (see FIG. 2). In the drawings, where appropriate, “rotor assembly” is abbreviated as “RA,” “motor assembly” as “MA,” and “ECU assembly” as “EA.”

For example, as a comparative example, in a case where the rear frame is formed as a metal heat sink, and heat from the heat-generating devices 54 is dissipated toward the motor case 16, it is necessary to mount the heat-generating devices 54 on the motor-side surface 531 of the circuit board 53 within the motor region.

In contrast, in the drive device 1 of this embodiment, the heat-generating devices 54 are resin-embedded in the ECU cover 71, and the structure dissipates heat to the ambient air through the ECU cover 71 that is in direct contact with the heat-generating devices 54. This enables the heat-generating devices 54 to be mounted on the cover-side surface 532 and even outside the motor region, thereby increasing the degree of freedom in circuit board design. In addition, an interposed material, such as thermal gel, which is required when dissipating heat to a metal heat sink, becomes unnecessary.

The ECU case 61 is integrally resin-molded with the motor case 16 by insert molding, and the one end portion of the motor case 16 is sealed by the ECU case 61. Additionally, the front frame 17 is integrally resin-molded with the motor case 16 by insert molding, and the other end portion of the motor case 16 is sealed by the front frame 17. This makes it possible, with a simple configuration and without any crevice-corrosion sites, to prevent the ingress of water drops, dust and the like into the interior of the device. In addition, because the connection between the ECU case 61 and the motor case 16 and the connection between the front frame 17 and the motor case 16 are sealed without using a sealing material such as an adhesive (i.e., sealant-less), no gap arises in response to aging deterioration of the sealing material, and the waterproof performance can be maintained over time. Desirably, the material of the ECU case 61 and the material of the front frame 17, which are integrally molded with the motor case 16, respectively have a coefficient of linear thermal expansion that is close to that of the material of the motor case 16.

In this embodiment, the motor case 16 is made of the metal, and the front frame 17 is made of the resin. In other words, instead of forming the motor case as a bottomed tubular shape such that the tubular portion and the portion opposite to the ECU 50 are formed as a single member, according to the present embodiment, the motor case 16 in the tubular shape and the front frame 17 in the substantially circular plate shape are separately formed. That is, the front frame 17 is formed by resin molding the front frame 17 onto the other end portion of the motor case 16 made of the metal. Thus, the motor case 16 and the front frame 17 form the integrally molded article. This makes it possible to separate the members without degrading the corrosion resistance. Note that, by making the motor case 16 as the separate member, the front frame 17 can be formed relatively easily, making it possible to use a material that has good corrosion resistance and relatively low flowability.

As described above, the drive device 1 includes the electric motor 10 and the ECU 50. The electric motor 10 includes: the motor housing 15 which includes the motor case 16 formed in the tubular shape; the stator 12 which is fixed to the motor housing 15; the plurality of motor wires 11 which are wound around the stator 12; the rotor 13 which is configured to be rotated in response to energization of the plurality of motor wires 11; and the shaft 14 which is rotatably supported by the motor housing 15 and is configured to be rotated integrally with the rotor 13.

The ECU 50 includes: the circuit board 53 on which the plurality of electronic components configured to control the drive operation of the electric motor 10 are mounted; and the ECU housing 601 that receives the circuit board 53. The ECU 50 is fixed to the one end portion of the motor case 16 in the axial direction of the electric motor 10. The electronic components include, for example, the heat-generating devices 54 and the capacitors 55. At least one (some in this instance) of the electronic components is sealed in a state where the at least one of the electronic components is embedded in the ECU housing 601 made of an electrically insulating material (dielectric material).

In the present embodiment, by adopting the structure in which the electronic components are resin-embedded in the ECU housing 601, heat, which is generated by energizing the electronic components, can be dissipated from the ECU housing 601 side. In addition, by dissipating the heat from the ECU housing 601, the components, which require the heat dissipation, can be disposed outside the motor region, and the degree of freedom in the design of the circuit board is higher compared with a case where heat is dissipated on the motor side, for example via the rear frame 18. Furthermore, by forming the ECU housing 601 from the electrically insulating material such as resin, an interposed material such as thermal gel, which would be required when dissipating the heat to a heat sink made of a metal material, becomes unnecessary.

The ECU housing 601 includes: the ECU case 61 fixed to the motor case 16; and the ECU cover 71 that seals the electronic components mounted on the cover-side surface 532, which is the surface of the circuit board 53 opposite to the electric motor 10. Accordingly, heat generated by the electronic components mounted on the cover-side surface 532 can be dissipated to the ECU cover 71.

The ECU case 61 seals the one end portion of the motor case 16 which faces the ECU 50. In this embodiment, the ECU case 61 sandwiches the radially inner side part and the radially outer side part of the motor case 16 and is integrally molded with the motor case 16. Accordingly, without using an adhesive or the like, the ECU 50 can be assembled to the motor case 16, whereby ingress of water droplets and foreign matter into the interior of the device from the connection between the electric motor 10 and the ECU 50 can be suppressed.

The electronic components include the heat-generating devices 54 that generate the heat when the heat-generating devices 54 are energized. The ECU cover 71 of the ECU housing 601 has a plurality of heat-dissipation fins 711 in a region, which overlaps with the heat-generating devices 54 upon projection of the heat-generating devices 54 onto this region in the axial direction. Accordingly, the heat dissipation efficiency of the heat-generating devices 54 can be improved.

### Second Embodiment

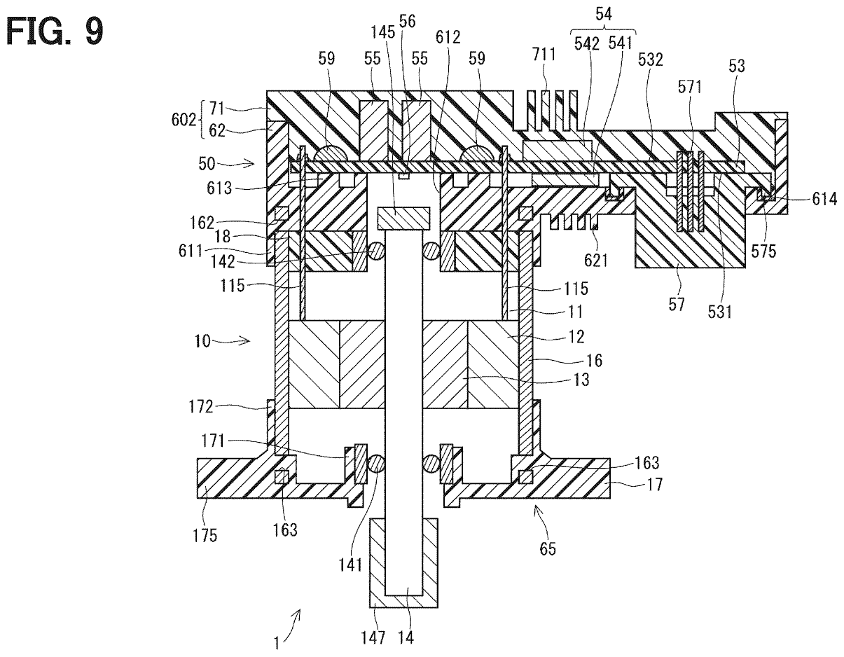

FIG. 9 shows the second embodiment. Since the second to eleventh embodiments mainly differ from the above-described embodiment in the ECU housing, the following description will focus on this point. The ECU housing 602 according to the second embodiment has an ECU case 62 and the ECU cover 71. The ECU case 62 has a plurality of heat dissipation fins 621.

In this embodiment, the heat-generating devices 54 are mounted on the motor-side surface 531 and the cover-side surface 532. Hereinafter, when distinguishing between the mounting surfaces as appropriate, the heat-generating devices, which are mounted on the motor-side surface 531 will be referred to as motor-side devices 541, and the heat-generating devices, which are mounted on the cover-side surface 532, will be referred to as the cover-side devices 542. The motor-side devices 541 are in contact with the ECU case 62 and dissipate the heat to the ECU case 62. A heat-dissipating gel or the like may be provided between the motor-side devices 541 and the ECU case 62.

The motor-side devices 541 are mounted outside the motor region of the circuit board 53. The heat-dissipating fins 621 are formed in the device-mounting region where the motor-side devices 541 are mounted. By arranging the motor-side devices 541 outside the motor region, the ECU case 62 can be provided with the configuration for improving the heat dissipation efficiency of the heat-dissipating fins 621 and the like, without interference with the motor case 16. Furthermore, the advantages similar to those described in the above embodiment can be achieved.

### Third Embodiment

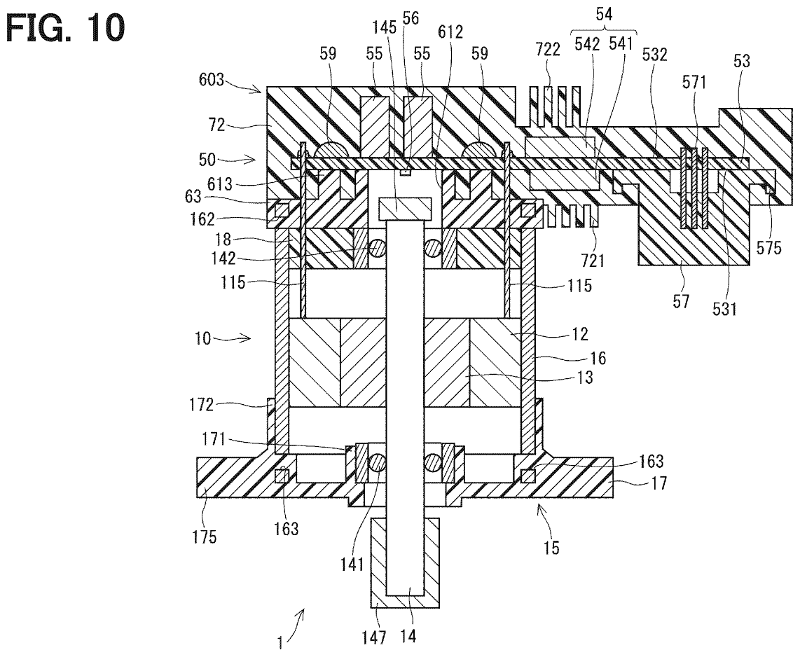

FIG. 10 shows the third embodiment. The ECU housing 603 according to this embodiment has an ECU case 63 and an ECU cover 72. The ECU case 63 is integrally molded with the motor case 16 such that the ECU case 63 is substantially received within the motor region. Although the outer-wall contact portion is omitted in FIG. 10, the outer-wall contact portion may be provided. The same applies to the embodiments described later.

The ECU cover 72 is formed to extend beyond the motor region in the radial direction and is integrally molded with the circuit board such that the ECU cover 72 seals the two opposite surfaces of the circuit board 53 with the resin. On the motor-side surface 531 side, the ECU cover 72 seals a region of the ECU case 63 located on the radially outward of the through-hole 612. That is, the rotational angle sensor 56, which is mounted inside the through-hole 612 of the motor-side surface 531, is not sealed by the ECU cover 72 and faces the sensor magnet 145 in an exposed state. The heat-dissipation fins 721, 722 are formed in the device-mounting region of the ECU cover 72 where the heat-generating devices 54 are mounted.

In the present embodiment, the ECU case 63 is integrally molded onto the motor assembly (S16 in FIG. 4), and the ECU assembly, to which the connector 57 is assembled, is mounted to the ECU case 63 (S18). Then, the circuit board 53 and the lead wires 115 are electrically connected (S19). Thereafter, the motor-side surface 531 and the cover-side surface 532 of the circuit board 53 are resin sealed to form the ECU cover 72 (S20).

The ECU cover 72 of the present embodiment integrally seals not only the devices mounted on the cover-side surface 532 of the circuit board 53, but also the connector 57 and the motor-side devices 541 mounted on the motor-side surface 531. As a result, the motor-side devices 541 are also embedded in the ECU cover 72 with the resin, allowing their heat to be dissipated to the ECU cover 72. Additionally, the step (S17) of connecting the connector 57 to the ECU case with the adhesive is no longer required. When the connector 57 is integrally molded with the ECU housing, the flange portion 575 may be omitted.

The ECU case 63 has the through-hole 612 in which the one end portion of the shaft 14, which faces the ECU 50, is disposed. The ECU cover 72 seals the electronic components which are mounted on the motor-side surface 531 of the circuit board 53 at the location outside the through-hole 612. Accordingly, heat generated by the electronic components mounted on the motor-side surface 531 can be also dissipated to the ECU cover 72. Furthermore, the advantages similar to those described in the above embodiment(s) can be achieved.

### Fourth Embodiment

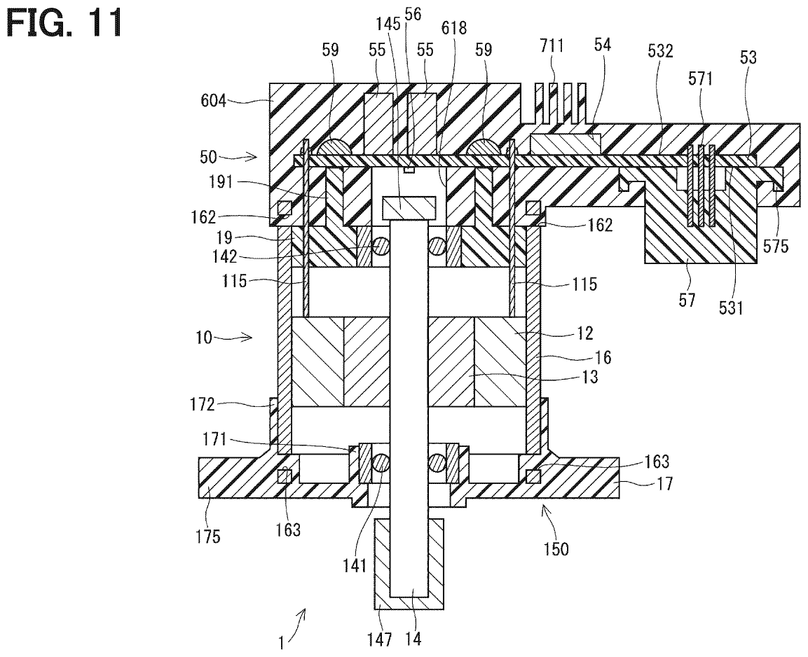

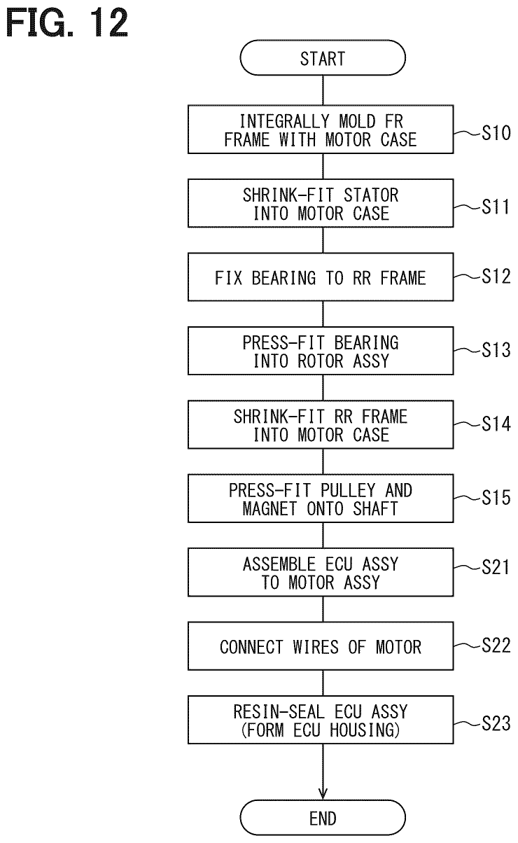

FIGS. 11 and 12 show the fourth embodiment. The ECU housing 604 of this embodiment is integrally molded with the motor case 16 and the circuit board 53 such that the ECU housing 604 resin seals the two opposite surfaces of the circuit board 53. That is, the ECU housing 604 of this embodiment can be regarded as a single member in which the ECU case and the ECU cover of the above-described embodiments are integrally formed in one-piece. The ECU housing 604 has an opening 618, in which the sensor magnet 145 is disposed and which opens toward the electric motor 10. The rotational angle sensor 56 is mounted on the motor-side surface 531 of the circuit board 53 at a location where the rotational angle sensor 56 is exposed in the opening 618 and faces the sensor magnet 145.

The motor housing 150 includes the motor case 16, the front frame 17 and a rear frame 19. The rear frame 19 has a plurality of circuit board holding portions 191 that protrude toward the ECU 50. The circuit board 53 is fixed to the circuit board holding portions 191 by means of fastening members 59, resin staking, or the like.

An assembly process of this embodiment will be described based on a flowchart in FIG. 12. The assembly of the motor assembly in S10 to S15 is the same as that shown in FIG. 4. In S21, which follows S15, the circuit board 53 is mounted on the circuit board holding portions 191, and the ECU assembly is assembled to the motor assembly. In S22, the circuit board 53 and the lead wires 115 are electrically connected, similar to S19 in FIG. 4. In S23, the motor case 16 and the ECU assembly are integrally resin sealed, and the ECU housing 604 is formed.

In this embodiment, the motor housing 150 includes the rear frame 19 which is fixed to the motor case 16 on the side of the stator 12 where the ECU 50 is disposed. The rear frame 19 has the circuit board holding portions 191, which project toward the ECU 50 and hold the circuit board 53. The ECU housing 604 integrally seals the one end portion of the motor case 16, which faces the ECU 50, and the two opposite surfaces of the circuit board 53. This makes it possible to reduce the number of components. Furthermore, it is possible to reduce the number of locations that require bonding with the adhesive or the like. Furthermore, the advantages similar to those described in the above embodiment(s) can be achieved.

### Fifth and Sixth Embodiments

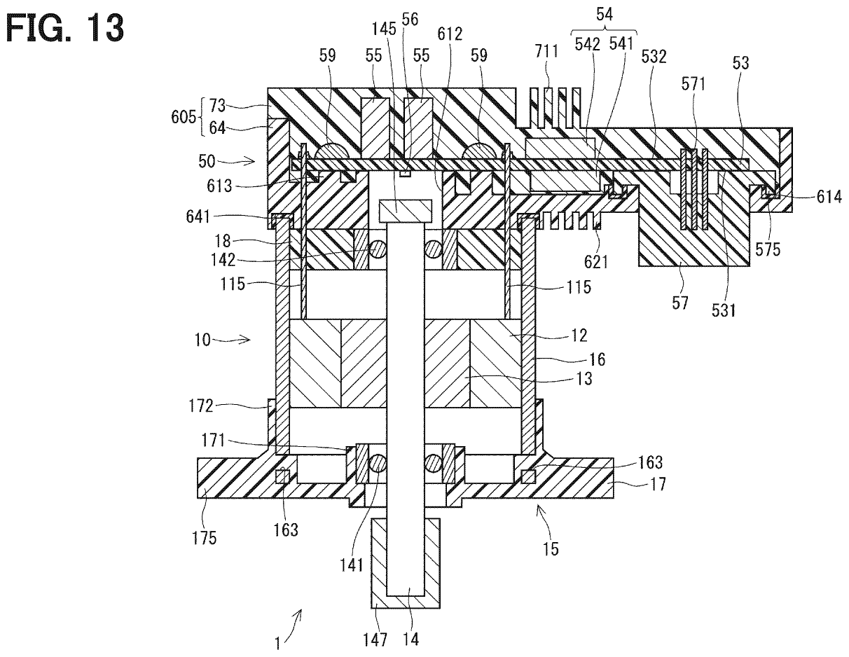

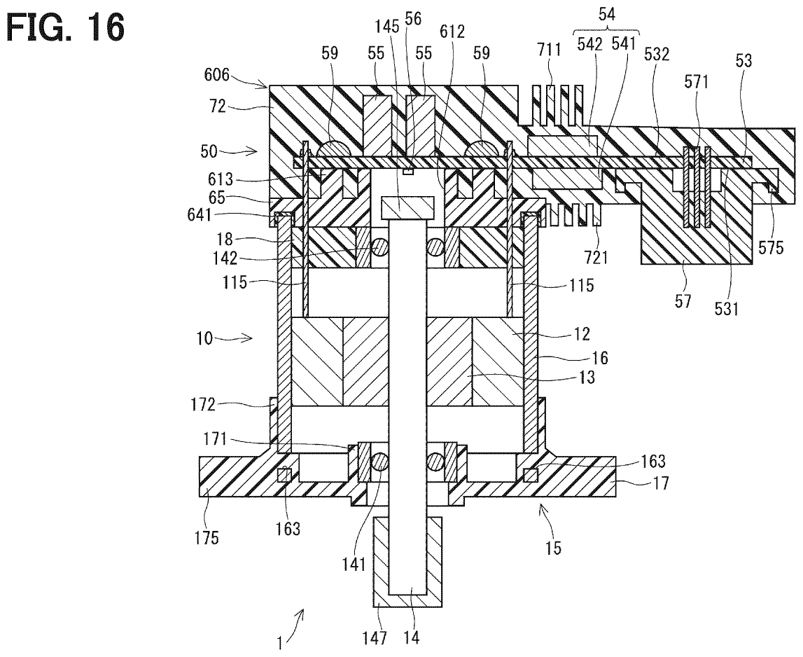

FIGS. 13 to 15 show the fifth embodiment, and FIG. 16 shows the sixth embodiment. As shown in FIG. 13, in the fifth embodiment, the ECU housing 605 includes an ECU case 64 and an ECU cover 73.

The ECU case 64 has an adhesive groove 641 into which the one end portion of the motor case 16, which faces the ECU 50, is inserted, and the ECU case 64 is formed separately from the motor case 16 from a resin such as polybutylene terephthalate (PBT). The motor case 16 of the present embodiment does not have the sealing holes 162. The ECU case 64 is mounted to the motor case 16 by an adhesive applied to the adhesive groove 641. The ECU case 64 extends to the outside of the motor region and has a plurality of heat-dissipating fins 621.

The ECU cover 73 is integrally molded with the ECU case 64 to resin seal the electronic components mounted on the cover-side surface 532 of the circuit board 53 and the electronic components mounted on the motor-side surface 531 outside the through-hole 612. The ECU cover 73 has a plurality of heat dissipation fins 711.

As shown in FIG. 16, in the sixth embodiment, the ECU housing 606 includes an ECU case 65 and the ECU cover 72. The ECU case 65 is formed separately from the motor case 16 and is substantially formed in the motor region. The ECU case 65 is the same as the ECU case 63 of the third embodiment, except that the ECU case 65 is mounted to the motor case 16 by an adhesive.

An assembly process of the drive device 1 will be described using the fifth embodiment as an example. An assembly flow is the same as that of the first embodiment, except that in the assembly of the motor assembly and the ECU case in S16 of FIG. 4, the motor case 16 and the ECU case 64 are fixed together by the adhesive instead of being integrally molded.

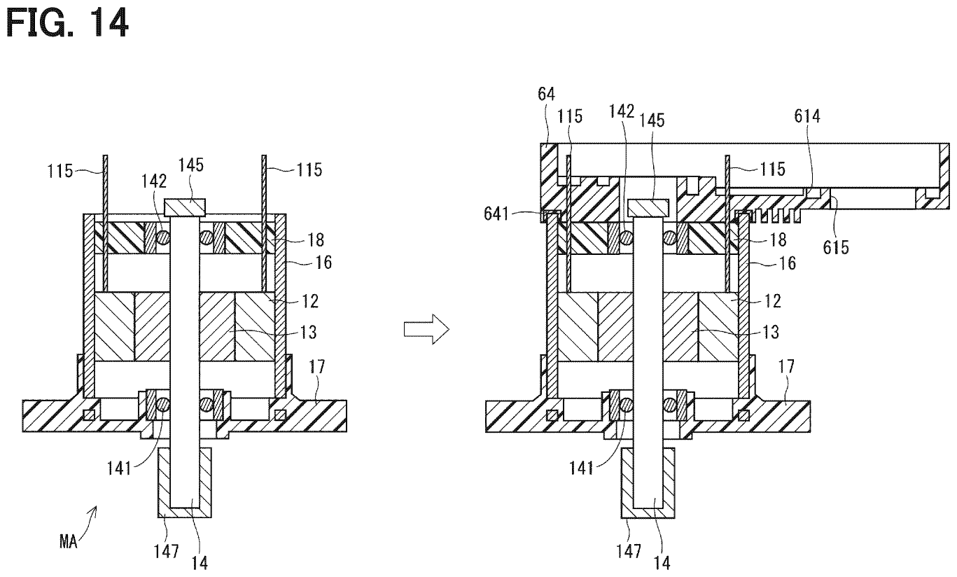

As shown in FIG. 14, the adhesive is applied to the adhesive groove 641 of the ECU case 64, and the one end portion of the motor case 16, which faces the ECU 50, is inserted into the adhesive groove 641. As a result, the ECU case 64 is assembled to the motor assembly.

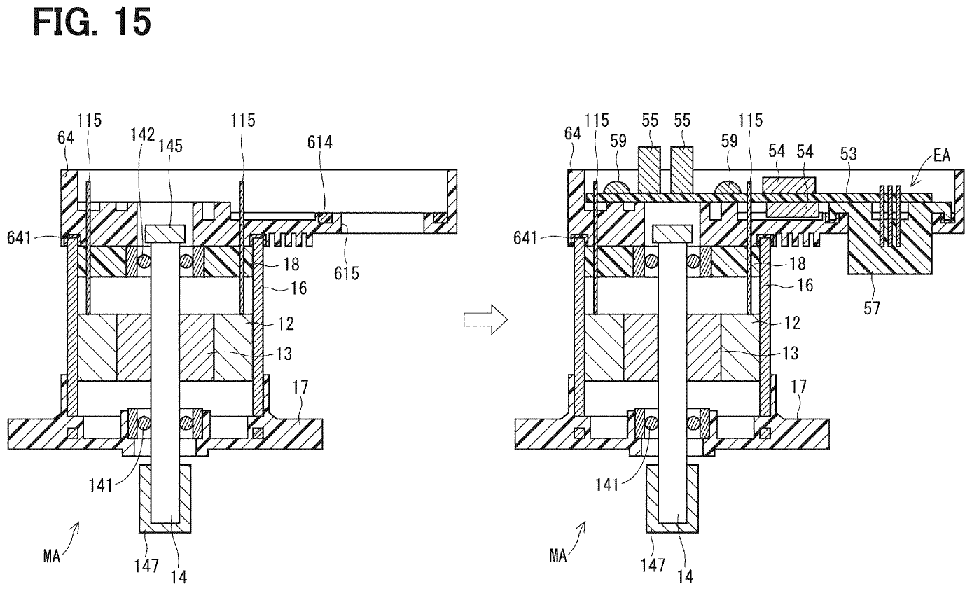

As shown in FIG. 15, the adhesive is applied to the connector mounting portion 614 of the ECU case 64, and the ECU assembly is assembled to the ECU case 64. Then, after the lead wires 115 and the circuit board 53 are electrically connected, the ECU assembly is resin sealed to form the ECU cover 73 (see FIG. 13).

By providing the ECU case 64, 65 as the body separate from the motor case 16, the ECU assembly can be relatively easily assembled to the motor assembly. Furthermore, the formation of the ECU case 64, 65 is facilitated. Furthermore, the advantages similar to those described in the above embodiment(s) can be achieved.

### Seventh and Eighth Embodiments

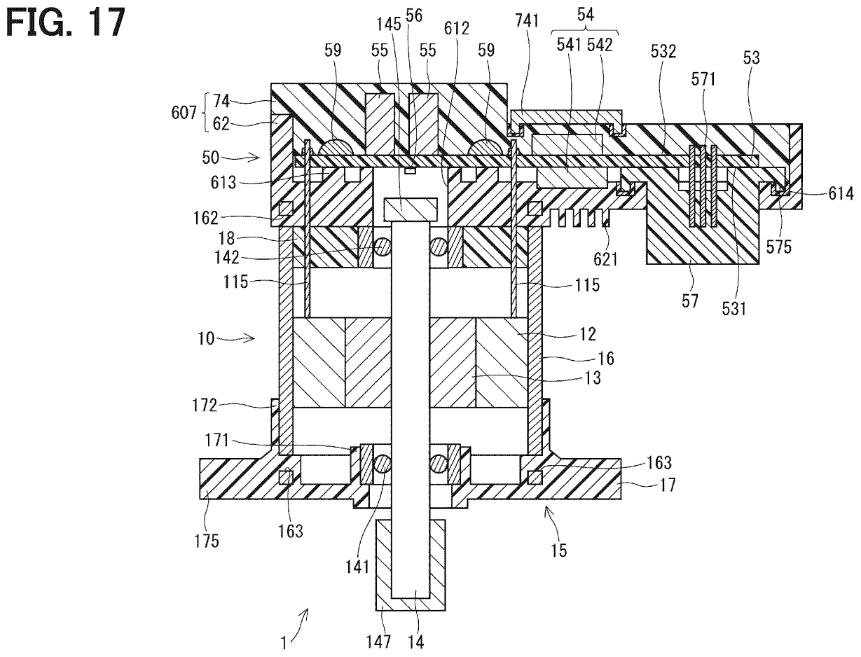

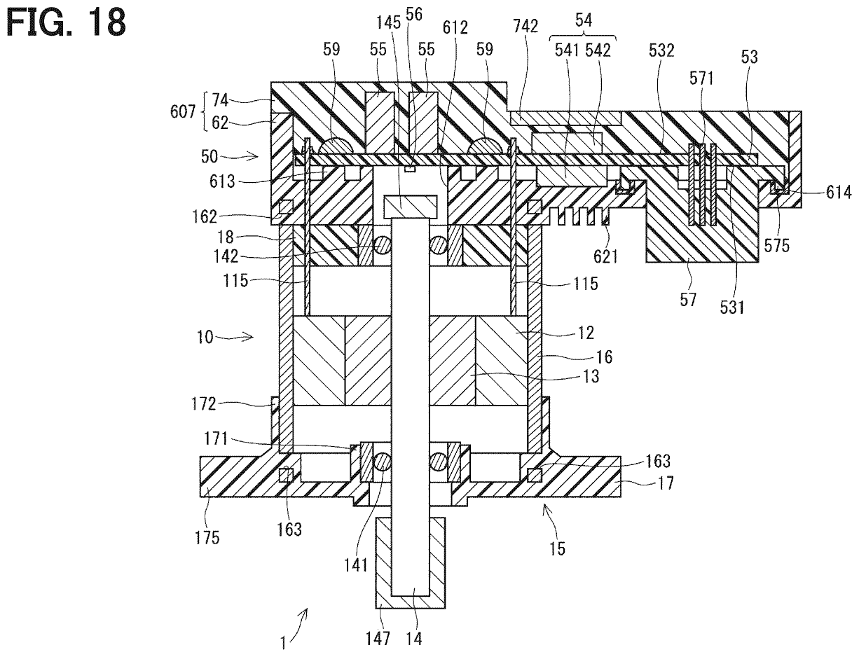

FIG. 17 shows the seventh embodiment, and FIG. 18 shows the eighth embodiment. As shown in FIG. 17, the ECU housing 607 of the seventh embodiment includes the ECU case 62 and an ECU cover 74. The ECU cover 74 is substantially the same as the ECU cover 71 of the first embodiment, except that the heat-dissipating fins are not formed on the ECU cover 74. A cover member 741 is mounted on a surface of the ECU cover 74 opposite the electric motor 10, in the device-mounting region where the heat-generating devices 54 are mounted. In the present embodiment, the cover member 741 is mounted to the cover member 741 with the adhesive or the like after the ECU cover 74 is integrally molded with the ECU case 62. Alternatively, as in the eighth embodiment shown in FIG. 18, a cover member 742, which is formed in a plate shape, may be insert-molded into the ECU cover 74 in the device-mounting region.

The cover member 741, 742 is made of, for example, a metal such as an iron plate with good thermal conductivity but may also be made of a resin. By providing the cover member 741, 742, the heat dissipation efficiency of the heat-generating devices 54 can be improved. Furthermore, the cover member 741, 742 functions as a reinforcement for the ECU cover 74.

In this embodiment, the ECU cover 74 of the ECU housing 607 has the cover member 741, 742 provided in the region, which overlaps with the electronic components upon projection of the electronic components onto this region in the axial direction. This makes it possible to protect the electronic components from external forces. Furthermore, by forming the cover member 741, 742 from a material with good thermal conductivity, thermal mass is added, and the heat dissipation efficiency can be improved. Furthermore, the advantages similar to those described in the above embodiment(s) can be achieved.

### Ninth Embodiment

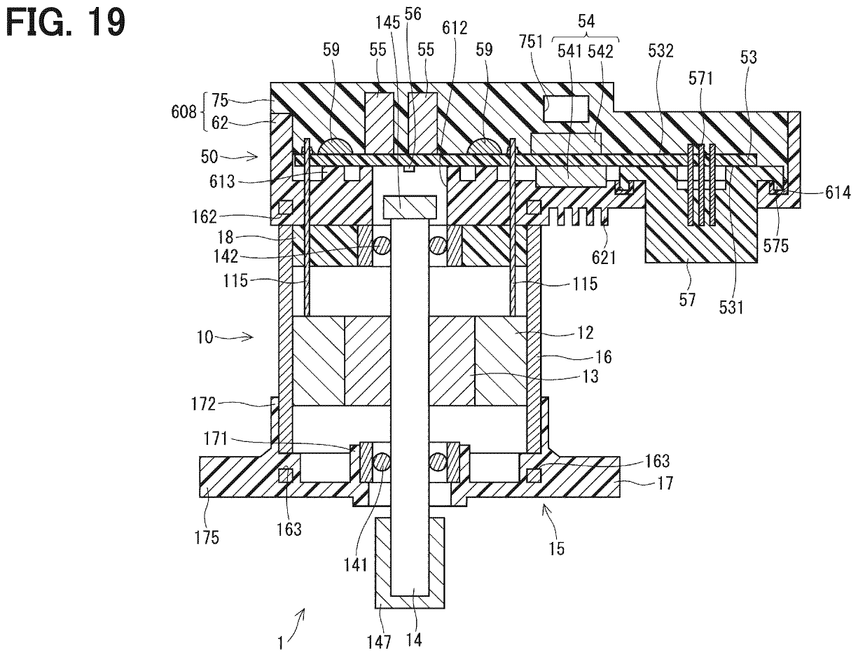

FIG. 19 shows the ninth embodiment. As shown in FIG. 19, the ECU housing 608 includes the ECU case 62 and an ECU cover 75. The ECU cover 75 has a flow passage 751, through which a fluid such as a coolant can flow, in the region which overlaps with the heat-generating devices 54 upon projection of the heat-generating devices 54 onto this region in the axial direction. This makes it possible to improve the heat dissipation efficiency of the heat-generating devices 54. Furthermore, the advantages similar to those described in the above embodiment(s) can be achieved. Note that the cover member 741, 742 and the flow passage 751 of the seventh to ninth embodiments may be provided on the ECU housing according to any of the embodiments.

### Tenth Embodiment

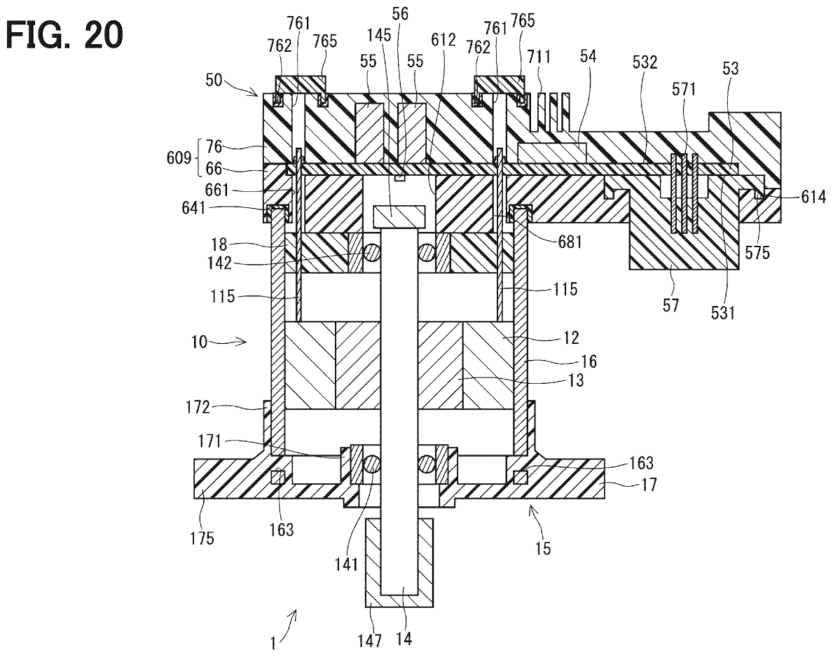

FIGS. 20 to 22 show the tenth embodiment. As shown in FIG. 20, the ECU housing 609 includes the ECU case 66 and an ECU cover 76. An ECU case 66 has the adhesive groove 641 and is fixed to the motor case 16 by the adhesive. The ECU case 66 has a plurality of lead wire insertion through-holes 661.

The ECU cover 76 is integrally molded with the ECU case 66. The ECU cover 76 has a plurality of communication holes 761 each of which connects a connection between the corresponding lead wire 115 and the circuit board 53 to the outside. A jig, which is used for connecting the circuit board 53 to the lead wire 115, can be inserted through the communication hole 761. An opening of each of the communication holes 761 is sealed with a corresponding one of a plurality of sealing covers 765. A bonding portion of each of the sealing covers 765 is inserted into a corresponding one of a plurality of adhesive grooves 762 and is joined to the ECU cover 76 with the adhesive.

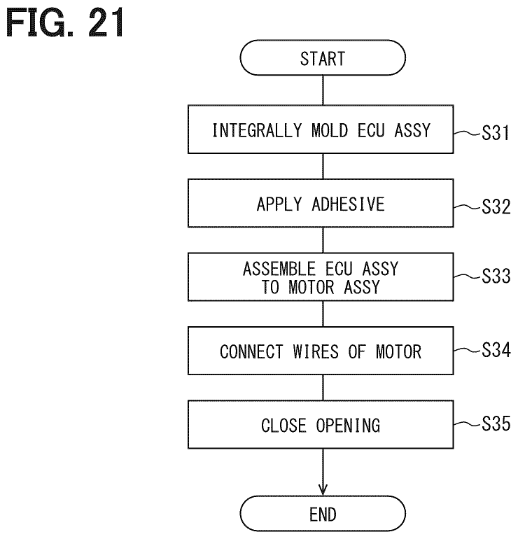

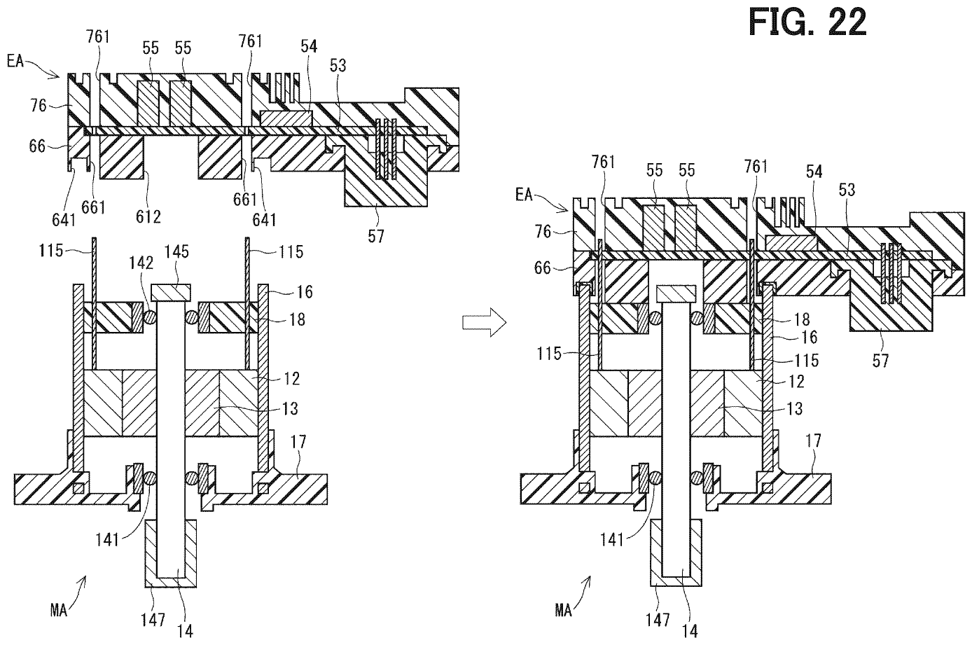

An assembly process of the drive device 1 according to this embodiment will be described with reference to a flowchart of FIG. 21 and FIG. 22. As shown in a left section of FIG. 22, in S31, the ECU assembly is integrally molded. Specifically, the ECU case 66 and the ECU cover 76 are integrally molded to resin seal the motor-side surface 531 and the cover-side surface 532 of the circuit board 53. In S32, the adhesive is applied to the adhesive groove 641.

As shown in a right section of FIG. 22, in S33, the resin sealed ECU assembly is assembled to the motor assembly. That is, in the present embodiment, the ECU assembly is formed separately from the motor assembly and then assembled together with the motor assembly. Since the assembly process of the motor assembly is the same as in the first embodiment, the description thereof will be omitted.

In S34, the lead wires 115 are electrically connected to the circuit board 53. In the present embodiment, since the communication holes 761 are provided, the jig can be inserted through each of the communication holes 761, and the corresponding lead wire 115 and the circuit board 53 can be connected together, for example, by soldering. In S35, each of the sealing covers 765 is mounted to close the opening of the corresponding communication hole 761 (see FIG. 20).

The ECU cover 76 of the ECU housing 609 has the communication holes 761 each of which connects the connection between the circuit board 53 and the corresponding motor wire 11 to the outside. The opening of each of the communication holes 761 is sealed with the corresponding one of the sealing covers 765. By forming the communication holes 761 in the ECU cover 76, the ECU assembly can be assembled to the motor assembly in the state where the ECU assembly is resin sealed. This makes the resin sealing of the ECU assembly relatively easy. Furthermore, the advantages similar to those described in the above embodiment(s) can be achieved.

### Eleventh Embodiment

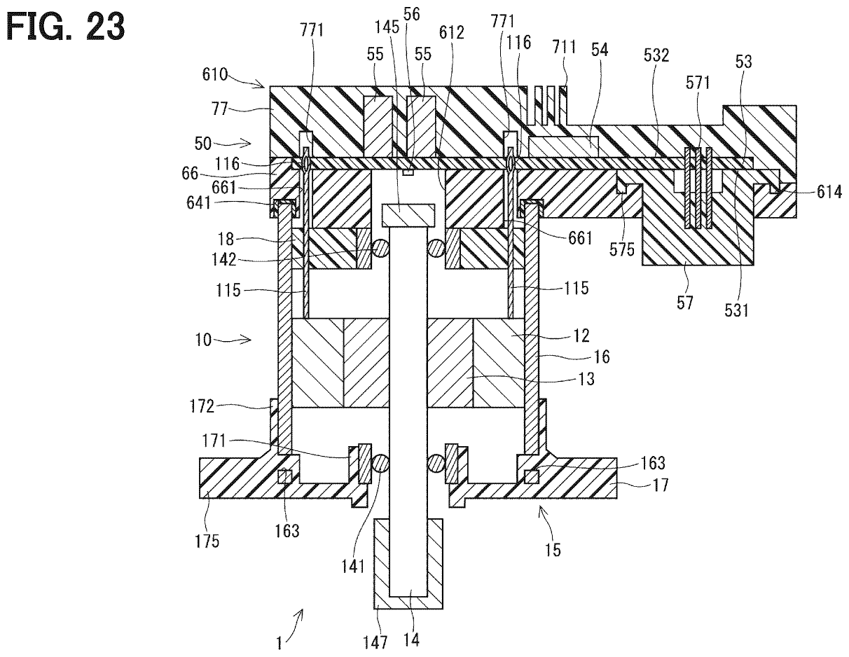

FIG. 23 shows the eleventh embodiment. The ECU housing 610 has the ECU case 66 and an ECU cover 77. The ECU cover 77 has a plurality of terminal relief grooves 771. Each of the terminal relief grooves 771 can receive a distal end portion of a corresponding one of the lead wires 115 and is not open to the outside.

In the present embodiment, the lead wires 115 and the circuit board 53 are electrically connected by a solderless connection without using solder. In the present embodiment, a press-fit portion 116 is formed at the distal end portion of each of the lead wires 115, and each of the lead wires 115 and the circuit board 53 are connected by resilient contact upon press-fitting of the press-fit portion 116. The connection between the lead wire 115 and the circuit board 53 is not limited to the press-fitting and may be made using, for example, a socket connector, as long as the electrical connection is possible without soldering. In other words, the solderless connection, which does not involve soldering, includes the connection by the resilient contact such as the press-fit connection, and the connection by fitting using the socket connector or the like.

The assembly process is substantially the same as in the tenth embodiment, but in this embodiment, since the lead wires 115 and the circuit board 53 are press-fit connected, the electrical connection between the motor assembly and the ECU assembly is completed at the stage where the resin-sealed ECU assembly is assembled to the motor assembly in S33. Furthermore, since there is no need to provide the communication holes and the sealing covers to seal the communication holes, the number of components and assembly steps can be reduced.

In this embodiment, the motor wires 11 are electrically connected to the circuit board 53 by the solderless connection. The ECU cover 77 of the ECU housing 610 has the terminal relief grooves 771 each of which is formed at the location corresponding to the connection between the lead wire 115 and the circuit board 53. By configuring the motor wires 11 and the circuit board 53 to be electrically connectable without the soldering, a soldering process after the assembly of the ECU assembly to the motor assembly can be omitted. Furthermore, the advantages similar to those described in the above embodiment(s) can be achieved.

In the embodiments described above, the rear frame 19 serves as a frame member, and the ECU 50 serves as the controller. Furthermore, the ECU housing 601-610 serves as a controller housing, and the ECU case 61-66 serves as a first housing. Also, the ECU cover 71-77 serves as a second housing, and the heat-generating devices 54 and the capacitors 55 serve as electronic components. Furthermore, the heat-generating devices 54 serve as heat-generating components, and the sensor magnet 145 serves as a detection target member.

### Other Embodiments

In the embodiments described above, there is described the example, in which the phenol resin is mainly used as the material for the front frame and the rear frame, and the epoxy resin or the PBT is used as the material for the controller housing. In another embodiment, the controller housing may be made of a material other than the epoxy resin or the PBT. In addition, the front frame and the rear frame may be made of a material other than phenol resin. For example, to further improve heat dissipation, the rear frame may be made of a metal with good thermal conductivity, such as an aluminum alloy. Alternatively, the motor case may be made of resin instead of aluminum.

In the embodiments described above, the motor case and the front frame are separate members, and the motor case is integrally molded with the front frame. In another embodiment, the motor case may be formed in a bottomed tubular shape that opens toward the controller, and the motor case and the front frame may be formed as a single member. As a supplementary note, even if the motor case is formed in the bottomed tubular shape, it shall be included in the concept of a motor case formed in a tubular shape.

In the embodiments described above, the sealing holes are formed in the motor case, and the motor case and the controller housing are integrally molded in the state where the motor case is sandwiched from the radially inner side and the radially outer side. In another embodiment, when the motor case and the ECU housing are integrally molded, the sandwiching the radially inner side part and the outer side part is not required. Furthermore, the sealing holes may be eliminated. The same applies to the connection between the motor case and the front frame.

In the embodiments described above, the heat-dissipation fins (ribs), the cover member and/or the flow passage are formed in the region, which overlaps with the heat-generating devices upon projection of the heat-generating devices onto this region in the axial direction. In another embodiment, depending on the thermal mass of the controller housing, the structure for improving the heat dissipation, such as the heat-dissipation fins, the cover member and the flow passage, may be omitted or may be provided in combination.

In the embodiments described above, the connector is provided on the motor-side surface of the circuit board, and the opening of the connector faces the output end side in the axial direction. In another embodiment, the connector may be provided on the cover-side surface of the circuit board, and the direction of the opening may be different from that of the embodiments described above. Also, a plurality of connectors may be provided instead of the one connector. Furthermore, the area of the circuit board, in which the devices are mounted, may be different from that of the embodiments described above.

In the embodiments described above, the controller is formed to extend radially outward beyond the motor region. In another embodiment, the controller may be provided within the motor region. In the embodiments described above, the drive device is applied to the electric power steering apparatus. In another embodiment, the drive device may be applied to in-vehicle apparatuses other than the electric power steering apparatus, or to apparatuses other than those used in the vehicle.

The present disclosure is not limited to the embodiments described above and can be implemented in various forms without departing from the spirit of the present disclosure.

The present disclosure has been described with reference to the embodiments. However, the present disclosure is not limited to the above embodiments and the structures described therein. The present disclosure also includes various variations and variations within the equivalent range. Also, various combinations and forms, as well as other combinations and forms that include only one element, more, or less, are within the scope and ideology of the present disclosure.

What is claimed is:

1. A drive device comprising:
an electric motor that includes:
a motor housing which includes a motor case formed in a tubular shape;
a stator which is fixed to the motor housing;
a plurality of motor wires which are wound around the stator;
a rotor which is configured to be rotated in response to energization of the plurality of motor wires; and
a shaft which is configured to be rotated integrally with the rotor; and
a controller that includes:
a circuit board on which a plurality of electronic components configured to control a drive operation of the electric motor are mounted; and
a controller housing that receives the circuit board, wherein:
the controller is fixed to one end portion of the motor case which faces in an axial direction of the electric motor;
the plurality of electronic components include:
a plurality of heat-generating components which are configured to generate heat when the plurality of heat-generating components are energized; and
a capacitor;
the plurality of heat-generating components include a plurality of switching devices of an inverter;
at least one of the plurality of switching devices is mounted on one surface of the circuit board opposite to the electric motor; and
among the plurality of electronic components, one or more electronic components, which include the at least one of the plurality of switching devices and are mounted on the one surface of the circuit board opposite to the electric motor, are sealed in a state where the one or more electronic components are embedded in the controller housing made of an electrically insulating material along with the circuit board including the one surface of the circuit board opposite to the electric motor.

2. The drive device according to claim 1, wherein the controller housing includes:
a first housing which is fixed to the motor case; and
a second housing which seals the one or more electronic components mounted on the one surface of the circuit board opposite to the electric motor.

3. The drive device according to claim 2, wherein:
the first housing has a through-hole which receives one end portion of the shaft that faces the controller; and
the second housing seals another one of the plurality of electronic components, which is other than the one or more electronic components, wherein the another one of the plurality of electronic components is disposed outside of the through-hole and is mounted on another surface of the circuit board which faces the electric motor.

4. The drive device according to claim 2, wherein the first housing seals the one end portion of the motor case which faces the controller.

5. The drive device according to claim 1, wherein:
the motor housing includes a frame member that is fixed to the motor case on a side of the stator where the controller is disposed, wherein the frame member includes a circuit board holding portion that projects toward the controller and holds the circuit board; and
the controller housing integrally seals:
the one end portion of the motor case, which faces the controller; and
the one surface and another surface of the circuit board which are opposite to each other.

6. The drive device according to claim 1, wherein a region of the controller housing, which overlaps with the plurality of heat-generating components upon projection of the plurality of heat-generating components onto the region in the axial direction, has at least one of:
a plurality of heat-dissipation fins; and
a flow passage that is configured to conduct a fluid.

7. The drive device according to claim 1, wherein a cover member is mounted on a region of the controller housing, which overlaps with the one or more electronic components upon projection of the one or more electronic components onto the region in the axial direction.

8. The drive device according to claim 1, wherein:
the controller housing has a communication hole that is configured to communicate a connection between the circuit board and one of the plurality of motor wires to an outside; and
an opening of the communication hole is closed by a sealing cover.

9. The drive device according to claim 1, wherein:
each of the plurality of motor wires is electrically connected to the circuit board by a solderless connection; and
the controller housing has a terminal relief groove at a location that corresponds to a connection between the circuit board and one of the plurality of motor wires.
